(19) United States
(12) Patent Application Publication
(10) Pub. No.: US 2006/0290643 A1
(43) Pub. Date: Dec. 28, 2006

(54) Organic electroluminscent display device

(75) Inventor: Yoshiaki Sakamoto, Kanagawa (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD., Minami-Ashigara-shi (JP)

(21) Appl. No.: 11/442,395

(22) Filed: May 30, 2006

(30) Foreign Application Priority Data
May 30, 2005 (JP) 2005-157490

(51) Int. Cl. G09G 3/36

(52) U.S. Cl. 345/99

(57) ABSTRACT

An organic electroluminescent display device in which a wiring layer, an insulating layer 3, first electrodes, an organic electroluminescent layer 5, and second electrodes 6 are laminated on a substrate 1, wherein the wiring layer sandwiched between a row of the first electrodes 4 and the substrate 1 comprises a plurality of feed wirings 2 extending in the row direction, and at least one first electrode 4 is connected to each feed wiring 2.

### CROSS-REFERENCE TO RELATED APPLICATION

This application claims priority under 35 USC 119 from Japanese Patent Application No. 2005-157490, the disclosure of which is incorporated by reference herein.

### BACKGROUND OF THE INVENTION

1. Field of the Invention

The present invention relates to an organic electroluminescent (EL) display device. Particularly, the present invention relates to an organic EL display device having a wiring structure for increasing luminance of a passive matrix driven organic EL display device, in a so-called top emission structure in which at least an opposite side to a substrate is designated as a screen.

1. Description of the Related Art

As a display device which can be made thin and lightweight as compared to conventional cathode-ray tubes (CRT) and liquid crystal displays (LCD), a display device using organic EL elements has recently attracted a great deal of attention.

Since the organic EL element is self-luminescent, it has various characteristics such as, the visibility is high, there is no viewing angle dependency, a film substrate having flexibility can be used, and it is thin and lightweight as compared to the liquid crystal display.

Of the organic EL display devices, the passive matrix driven organic EL display device configured with an organic EL layer sandwiched at crossing portions between a plurality of anodes and cathodes, which cross each other, makes a plurality of light emitting elements emit light sequentially to form a screen, by applying a drive signal, with each electrode wiring designated as a data line and a scan line.

The plurality of light emitting elements constituted on one data line emit light corresponding to a signal of each scan line, and control light emission from all pixels by sequentially scanning the scan lines, to draw the whole screen. One example of such a drive panel configuration will be described with reference to FIG. 7.

FIG. 7 is a diagram for explaining one example of a conventional passive matrix driven panel configuration (for example, see Japanese Patent Application Laid-Open No. 11-311978). This panel configuration includes; a cathode scanning circuit 41 comprising scan switches 43 with one end thereof connected to cathode lines 42, and the other end connected to either a supply voltage or a ground potential, an anode drive circuit 44 comprising drive switches 47 with one end thereof connected to anode lines 45, and the other end connected to a current source 46, an anode reset circuit 48 comprising a shunt switch 49 with one end thereof connected to the anode lines 45, and the other end connected to the ground potential, and a light emission control circuit 50.

The light emission control circuit 50 controls the cathode scanning circuit 41, the anode drive circuit 44, and the anode reset circuit 48 based on luminescence data, to make the organic EL layer at crossing positions between the cathode lines 42 and the anode lines 45 emit light, thereby performing display.

Here, light emitting positions are indicated by diodes, non-light emitting positions are indicated by capacitors, and non-light emitting positions in a charged state due to previous light emission are indicated by capacitors with oblique lines.

In Japanese Patent Application Laid-Open No. 11-311978, a drive example in which the number of pixels is 256×64, and the number of scan lines is 64 is disclosed.

The light emitting time given to each light emitting element in this case is within a width of a scan signal (=frame cycle T/number of scan lines N), and the luminance is determined by the current which has flowed to the pixels within the light emitting time.

That is to say, as the width of the scan signal increases and the light emitting time becomes longer, a higher luminance is obtained. Therefore, in order to obtain a high luminance with the passive matrix driven organic EL display device, a long light emitting time (a wide width of scan signal) is required.

However, when the number of pixels increases as the display device has higher definition, the number of scan lines increases. Therefore, the light emitting time becomes shorter, making it difficult to ensure sufficient luminance.

Conventionally, therefore, in a screen configuration having a large number of pixels and a large number of scan lines, it has been proposed to divide the scan region on the screen to form a plurality of data lines corresponding to each scan region, thereby enlarging the width of the scan signal.

For example, in a QVGA screen (320×240 pixel configuration), the width of the scan signal is T/240 without dividing the scan region, but when the scan region is divided into two, 320 data lines are respectively drawn upwards and downwards of the screen, and the width of the scan signal becomes T/120, which is twice the width of the scan signal without the division, thereby obtaining twice the luminance Moreover, when the scan region is divided into four, two sets of 320 data lines are drawn upwards and downwards of the screen, and the width of the scan signal becomes T/60, which is four times the width of the scan signal without the division. As a result, long light emitting time can be obtained, thereby obtaining high luminance.

FIG. 8 is a schematic cross-sectional view of a configuration example of a scan region dividing type organic EL display device. Since this is a bottom emission structure in which light emission is drawn to the outside through a transparent substrate 51 and transparent pixel electrodes 54, data lines 52 corresponding to the number of divided scan regions are arranged between pixels.

Reference numerals 53, 55, and 56 in the drawing respectively denote an interlayer insulating film, an organic EL layer, and an upper electrode.

However in this configuration, since the data lines 52 are formed for each of the divided scan regions, the number of data lines increases in proportion to the division number, thereby causing problems such that the area between the pixels for arranging the data lines 52 increases, decreasing the opening area (light-emitting area), and the luminance is not simply improved in proportion to the enlargement of the width of the scan signal.

For example, as one example, if it is assumed that the aperture ratio is 90% in the case of two-divisions, depending on the pattern rule, then in the case of four-divisions, the light emitting time becomes double, but the aperture ratio becomes about 57%. Hence, the luminance ratio becomes (57/90)×2≈1.27, which means that the luminance is increased by about 27% as compared to the case of two-divisions.

However, in the case of eight-division, while the light emitting time becomes four times longer than that in the case without the division, the aperture ratio becomes about 19%, and hence, the luminance ratio becomes (19/90)×4≈0.84, which means that the luminance decreases by about 16% as compared to the case of two-divisions, and the effect by dividing the scan region cannot be obtained.

Therefore, to solve such a problem, it has been proposed to arrange the wiring in a three-dimensional multilayer structure (for example, see Japanese Patent Application Laid-Open No. 2004-288607), which will be described here with reference to FIG. 9.

FIG. 9 is a schematic cross-sectional view of a configurational example of the scan region dividing type organic EL display device in which the data lines are multilayered, wherein data lines 57 and 59 corresponding to the number of divided scan regions are laminated and arranged between the pixels. In this structure, even when the division number of the scan region increases, the aperture ratio can be kept constant, and high luminance becomes possible in the high-definition organic EL display device.

Reference numerals 58 and 60 in the drawing respectively denote interlayer insulating films. Reference numerals 51, 54, 55 and 56 in the drawing respectively denote a transparent substrate, transparent pixel electrode, organic EL layer and upper electrode.

When the data lines are multilayered, the aperture ratio can be kept constant, but there is a problem in that the production cost increases, since the production processes increase and become complicated corresponding to the number of laminations of the wiring layers.

The present invention has been made in view of the above circumstances and provides an organic electroluminescent display device.

### SUMMARY OF THE INVENTION

An aspect of the present invention is to provide an organic electroluminescent display device in which a wiring layer, an insulating layer, first electrodes, an organic electroluminescent layer, and second electrodes are laminated on a substrate, with luminescence in the organic electroluminescent layer being transmitted through the second electrodes, wherein the wiring layer sandwiched between a row of the first electrodes and the substrate comprises a plurality of feed wirings extending in the row direction, and at least one first electrode is connected to each feed wiring.

### BRIEF DESCRIPTION OF THE DRAWINGS

FIG. 1 is a diagram for explaining a fundamental configuration of the present invention.

FIG. 2 is a driving circuit diagram of an organic EL display device of the present invention.

FIG. 3A-FIG 3C are diagrams for explaining the organic EL display device of the present invention.

FIG. 4 is a pattern block diagram of the organic EL display device of Example 1 of the present invention.

FIG. 5 is an enlarged view of the main parts of a scan region.

FIG. 6 is a diagram for explaining a drive example of the organic EL display device of Example 1 of the present invention.

FIG. 7 is a diagram for explaining one example of a conventional passive matrix driven panel configuration.

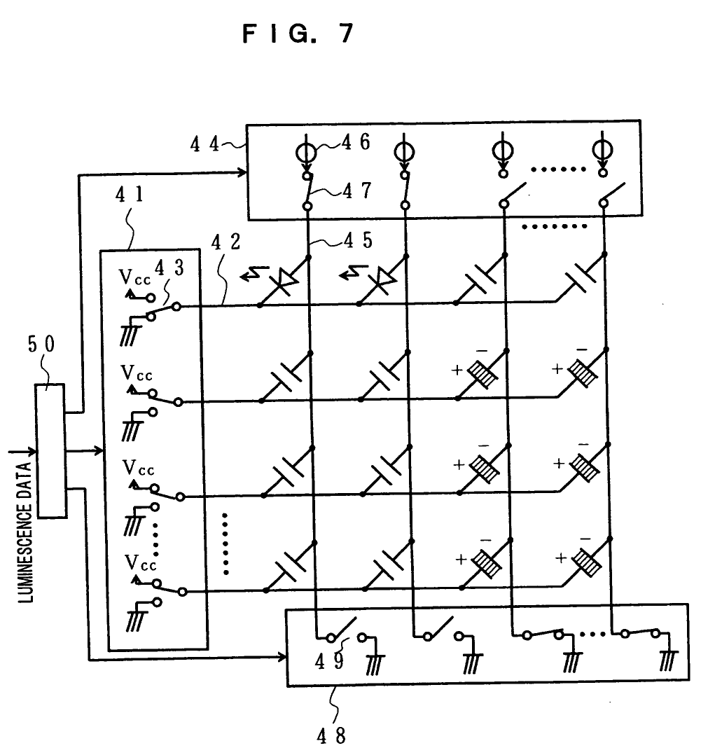

FIG. 8 is a schematic cross-section of a configuration example of a scan region dividing organic EL display device.

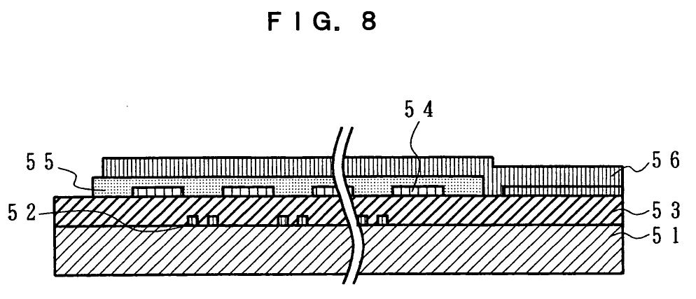

FIG. 9 is a schematic cross-section of a configuration example of a scan region dividing organic EL display device in which data lines are multilayered.

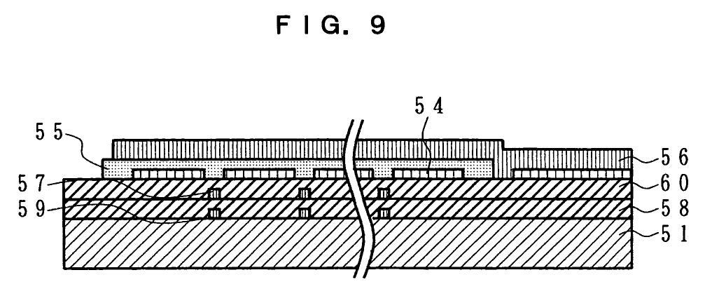

### DETAILED DESCRIPTION OF THE INVENTION

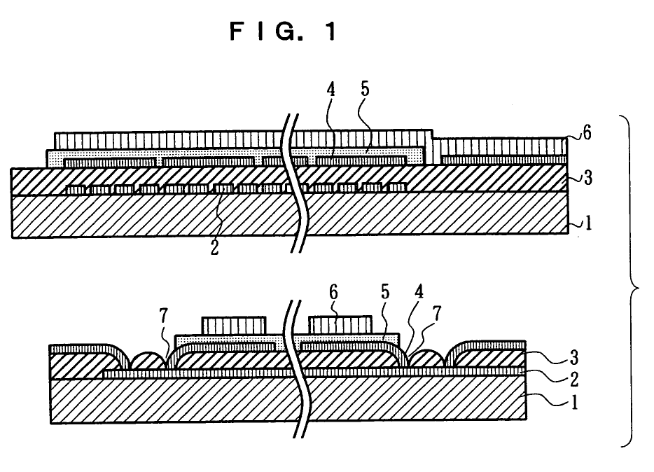

FIG. 1 is a fundamental block diagram of the present invention. Here the present invention will be explained with reference to FIG. 1.

The present invention provides an organic electroluminescent (EL) display device in which a wiring layer, an insulating layer 3, first electrodes 4, an organic EL layer 5, and second electrodes 6 are laminated on a substrate 1, with luminescence in the organic EL layer 5 being transmitted through the second electrodes 6, wherein the wiring layer sandwiched between a row of the first electrodes 4 and the substrate 1 comprises a plurality of feed wirings 2 extending in the row direction, and at least one first electrode 4 is connected to each feed wiring 2. Reference numeral 7 is a connecting portion between the feed wiring 2 and the first electrode 4.

In this manner, a top emission type organic EL display device is made, with the luminescence in the organic EL layer 5 being drawn by being transmitted through the second electrode 6. Hence, the feed wiring 2 arranged below the organic EL layer 5 does not affect the aperture ratio. As a result, a high aperture ratio and a wide width of scan signals can be both obtained, thereby enabling realization of a high-intensity and high-definition organic electroluminescent display device.

In this case, preferably a plurality of the first electrodes 4 is connected to each feed wiring 2, and the plurality of first electrodes 4 is arranged adjacent to each other, thereby forming a continuous pixel row. As a result, arrangement configuration is simplified.

Moreover, preferably the feed wirings 2 corresponding to pixel rows within the screen passes through a region of the pixel row closer to an outer periphery of the screen than the pixel rows, and are drawn out to the outer periphery of the screen, thereby making a draw-out space of the feed wirings 2 compact.

Furthermore, as a general configuration, a plurality of the second electrodes 6 is connected to the feed wirings 2 in a direction crossing the pixel row, to constitute a passive matrix driven pixel circuit in which the first electrodes 4 side is designated as signal lines, and the second electrodes 6 side is designated as scan lines. As a result, a high-intensity and high-definition passive driven organic electroluminescent display device can be realized.

In this case, preferably the feed wiring 2 is divided into two at the center of the screen, and is drawn out toward the two outer peripheral positions of the screen opposite to each other. As a result, the longest distance from the pixel to the end of the feed wiring 2 can be reduced to about half the distance for when the feed wiring is not divided, and a line width of the feed wiring 2 can be approximately doubled.

Moreover, preferably a connecting portion 7 between the feed wiring 2 and the first electrode 4 is provided at a position where it does not overlap projectively on the second electrode 6. As a result, it is possible to prevent that the organic EL layer 5 becoming thin at an edge of the connecting portion 7, and short-circuiting the first electrodes 4 and the second electrodes 6, and a rib width between openings provided in a deposition mask for depositing the second electrodes 6 can be sufficiently ensured, thereby enabling suppression of deformation of the deposition mask.

Furthermore, in the case where the aforementioned pixel circuit comprises M×N pixels, if the scan region is divided into S regions, the number of signal lines in one scan region becomes M lines, and the number of scan lines becomes N/S lines.

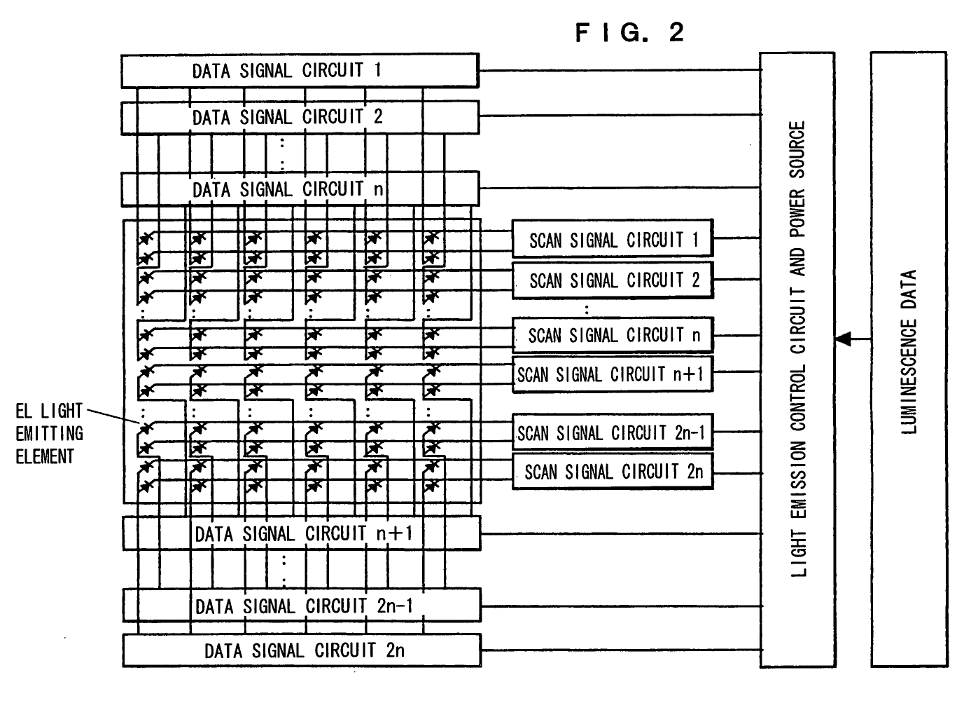

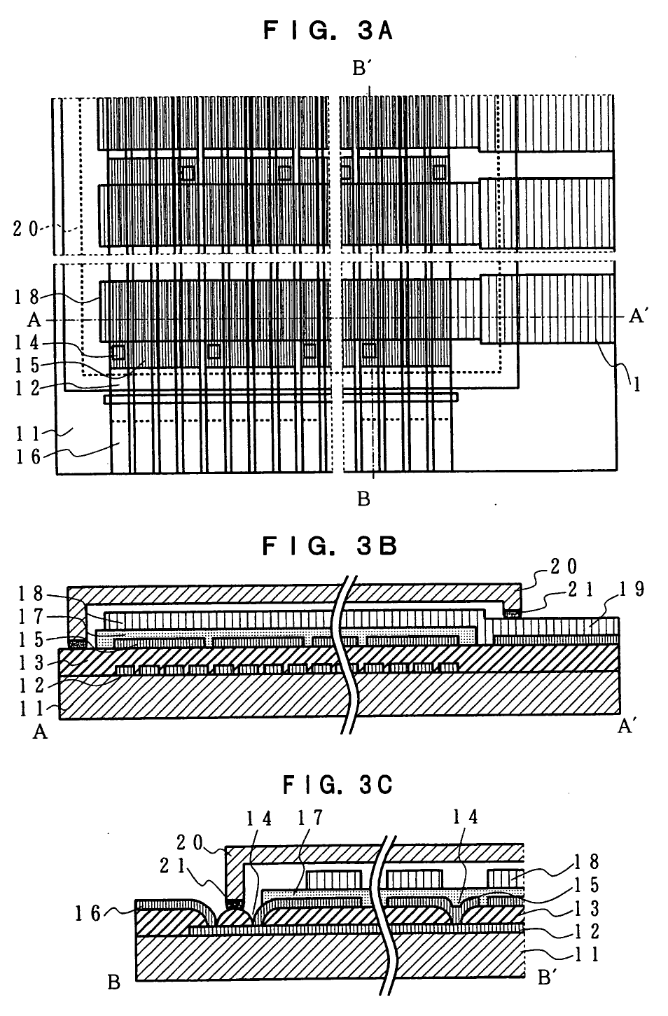

Here, the a mode for carrying out the invention will be explained with reference to FIG. 2 and FIGS. 3A-3C.

FIG. 2 is a driving circuit diagram of the organic EL display device of the present invention. Here the screen is divided into 2n screens to form data signal circuits 1 to 2n corresponding to respective scan signal circuits 1 to 2n, and the data signal circuits 1 to 2n are divided into two, vertically and arranged on the screen.

The respective scan signal circuits and data signal circuits are driven by a light emission control circuit in response to an input of luminescence data, to simultaneously drive respective scan regions comprising the data signal circuit and the scan signal circuit, thereby lighting EL light emitting elements indicated by diodes at selected positions, to perform display.

FIGS. 3A-3C are diagrams for explaining the organic EL display device of the present invention. FIG. 3A is a schematic perspective plan view of the main parts, and FIG. 3B and FIG. 3C are respectively schematic cross-sectional views along the one-dot chain line connecting A-A′, and the one-dot chain line connecting B-B′ in FIG. 3A.

An aluminum (Al) layer is deposited on a glass substrate 11 by means of a sputtering method, after which a predetermined number of data lines 12 are formed by using a general photo-etching process.

Subsequently, a photosensitive resin is coated over the whole surface, and contact holes 14 for connecting the data lines 12 to pixel electrodes 15 are formed above the data lines 12 using a photolithographic process, and the remaining photosensitive resin is designated as an interlayer insulating film 13.

Openings are also provided above the data lines 12 at terminal portions connected to data line terminals 16.

The contact holes 14 for connecting the data lines 12 to the pixel electrodes 15 in this case, are provided for the number of the scan lines (upper electrodes 18 in the drawing) allocated corresponding to the scan regions divided with respect to one data line 12.

Next an Al layer is deposited over the whole surface by the sputtering method, after which the pixel electrodes 15 in a number corresponding to the number of pixels are formed by using a general photo-etching process, and the data line terminals 16 for connection to an external driving circuit are formed simultaneously, and connected to the data lines 12 via the contact holes formed in the interlayer insulating film 13.

The pixel electrodes 15 made from Al function as optical reflecting surfaces and cathodes.

Next, an organic EL layer 17 which covers a screen forming area is formed on the pixel electrodes 15 using a metal mask, by sequentially mask-depositing from the pixel electrodes 15 side; an electron injection layer, an electron transport layer, a light emitting layer, a hole transport layer, and a hole injection layer.

Subsequently, since the organic EL layer 17 is likely to be affected by heat, an indium tin oxide layer (ITO layer) is formed in a stripe shape extending in a direction crossing the data lines 12, by a mask deposition method using a reactive plasma deposition method capable of low temperature deposition, thereby forming the upper electrodes 18 and scan line terminals 19.

The upper electrodes 18 function as scan lines and anodes.

Lastly, in order to shield the organic EL layer 17 from the air, a sealing plate 20 made from glass having optical transparency, is formed so as to cover the screen and expose the data line terminals 16 and the scan line terminals 19, and is sealed by a UV-hardening adhesive 21. As a result, the basic configuration of the organic EL display device is completed.

Here, an example in which four data lines 12 are provided with respect to one pixel row, that is, an example in which the scan region is divided into eight, is shown in the drawing.

In the organic EL display device, as shown in FIG. 2, by selectively energizing the upper electrode 18 serving as the scan lines, and the data lines 12, a desired organic EL layer 17 sandwiched between the pixel electrode 15 and the upper electrode 18 is made to emit light, to perform display.

### EXAMPLE 1

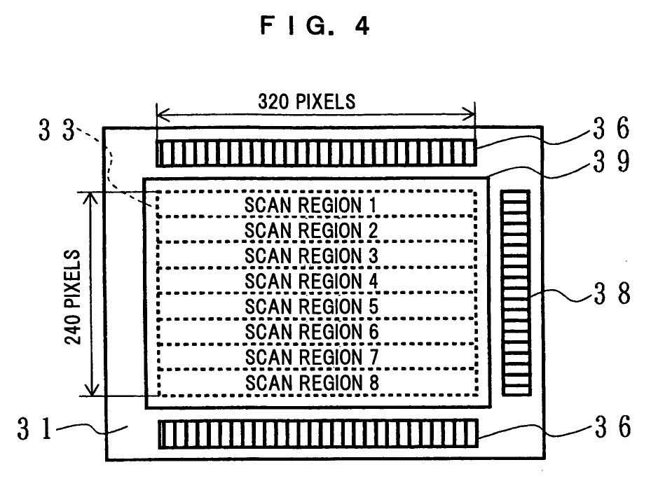

Next a specific example 1 of the present invention, which is a QVGA specification having a screen size of 64 mm×48 mm (3.2 type), and a number of pixels of 320×240, will be explained, with reference to FIG. 4 to FIG. 6. In this case, the pixel pitch becomes 0.2 mm (=48 mm/240), and the definition becomes 127 ppi.

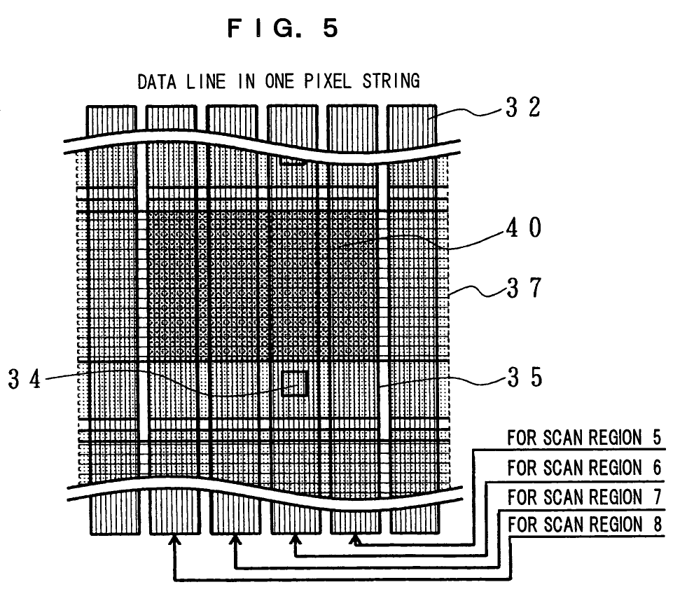

FIG. 4 is a pattern block diagram of the organic EL display device of Example 1 of the present invention. Moreover FIG. 5 is an enlarged view of the main parts of the scan region 6. 240 scan lines are divided into eight, and the number of scan lines in one scan region 33 is 30 (=240/8).

The overall basic planar structure and sectional structure are the same as those shown in FIG. 3.

320 data lines 32 are formed for each scan region 33, and hence, the total number of data lines becomes 2560 (=320×8 regions). However, since the data line terminals 36 for drawing out the data lines 32 are evenly distributed to two sides of the screen in the longitudinal direction, 1280 (=320×4 regions) data lines for four scan regions are drawn out to one side.

That is, since four data lines 32 are drawn out for each pixel row, and the four data lines 32 are formed within the pixel pitch of 0.2 mm, the pitch between the data lines 32 becomes 0.05 mm (=0.2 mm/4). Here, a space of 0.01 mm is provided between the data lines 32, thereby setting the width of the data line 32 to 0.04 mm.

The length of the data line 32 in this case may be arranged from the end of the glass substrate 31 to at least the scan region 33 to be driven. Here, in order to obtain uniformity of the machining shape of the wiring pattern, all the data lines 32 are drawn from the end of the glass substrate 31 to the center of the screen, and a space of 0.01 mm is provided at a portion where the tips of the data lines 32 drawn from the opposite ends face each other at the center of the screen.

The data lines 32 are formed from an Al layer having a thickness of for example 200 nm.

Moreover, in the interlayer insulating film, a contact hole 34 of 0.03 mm is formed above the data line 32 by coating a photosensitive polyimide layer having a thickness of, for example, 3 m thereon, and performing patterning by a photolithographic process.

In a heating process for imidation, the cross-section of the edge of the contact hole 34 has a tapered angle of 45 degrees or less, so that stepped coating becomes possible in a subsequent process for forming thin layer electrodes.

The contact holes 34 are formed at a pixel pitch of 0.2 mm above one data line in one pixel row in one scan region 33, and contact holes in other scan regions are not formed on the same data line.

Moreover, the contact hole (not shown) for a data line terminal 36 formed later is also formed above all the data lines 32 at the edge of the glass substrate 31.

Furthermore, the pixel electrodes 35 comprise an Al layer having a thickness of, for example, 100 nm, and are formed within the 0.2 mm□ pixel pitch. In this case, 320×240 pixel electrodes 35 are formed corresponding to the number of pixels, with a space between pixel electrodes 35 being 0.01 mm and the size of the electrode being 0.19 mm.

At this time, the respective pixel electrodes 35 are connected to the corresponding data lines 32 via one contact hole 34, respectively. Furthermore, in this process, 2 mm×0.04 mm data line terminals 36 are formed at the edge of the glass substrate 31, and each data line terminal 36 is connected to the corresponding data line 32 via one contact hole, respectively.

Moreover, the organic EL layer is formed by depositing; the electron injection layer formed from CsF having a thickness of, for example, 1 nm, the electron transport layer formed from Alq3 (tris(8-hydroxyquinolinate) aluminum) having a thickness of, for example, 20 nm, the light emitting layer obtained by doping host Alq3 having a thickness of, for example, 30 nm, with a light emitting material t(npa)py(1,3,6,8-tetra[N-(naphthyl)-N-phenylamino]pyrene, the hole transport layer formed from α-NPD(N,N′-dinaphthyl-N,N′-diphenyl-[1,1′-biphenyl]-4,4′-diamine) having a thickness of, for example, 20 nm, and the hole injection layer formed from MTDATA[4,4′,4″-tris(3-methylphenylphenylamino)triphenylamine] having a thickness of, for example, 30 nm, sequentially from the glass substrate 31 side, in an area of 66 mm×50 mm by vacuum deposition using a metal mask, so as to cover the entire pixel electrodes 35.

Furthermore, the upper electrodes 37 comprise ITO having a thickness of, for example, 200 nm, and are formed as a scan line pattern by a reactive plasma-deposition method using a metal mask having a striped opening.

The upper electrodes 37 are formed so as to cross between the pixels in an orthogonal direction to the data lines 32. The width of the upper electrodes 37 is 0.135 mm in an area avoiding the contact hole 34 and within 0.19 mm, which is the width of the pixel electrodes 35, and the length thereof combining the length crossing the long edge of the screen and the scan line terminal 38 for external connection is set to 70 mm.

Thus, since the width of the upper electrodes 37 is formed so as to avoid the contact holes 34, it is possible to prevent the layer thickness of the organic EL layer and the like becoming thin at the edge of the contact holes 34, and short-circuiting the pixel electrodes 35 and the upper electrodes 37.

Moreover a rib width of 0.065 mm between the stripe openings can be ensured in the metal mask for forming the upper electrodes 37. As a result, the rigidity can be ensured, to prevent deformation of the mask shape.

Lastly, a glass sealing plate 39 for sealing is bonded to the glass substrate 31 by using a UV hardening adhesive so as to cover the area of 70 mm×54 mm in which the data line terminals 36 and the scan line terminals 38 are exposed.

Therefore, in the pixels in the organic EL display device in Example 1, a light emitting region 40 in an area of pixel pitch 0.2 mm×0.2 mm becomes 0.19 mm×0.135 mm corresponding to the width 0.19 mm of the pixel electrode 35 and the width 0.135 mm of the upper electrode 37, and the aperture ratio becomes 64%.

The data line terminals 36 and the scan line terminals 38 are connected to the driving circuit by a flexible print circuit (FPC) to perform passive matrix drive, thereby making the 320×240 pixels forming the screen, to optionally emit light, to display information.

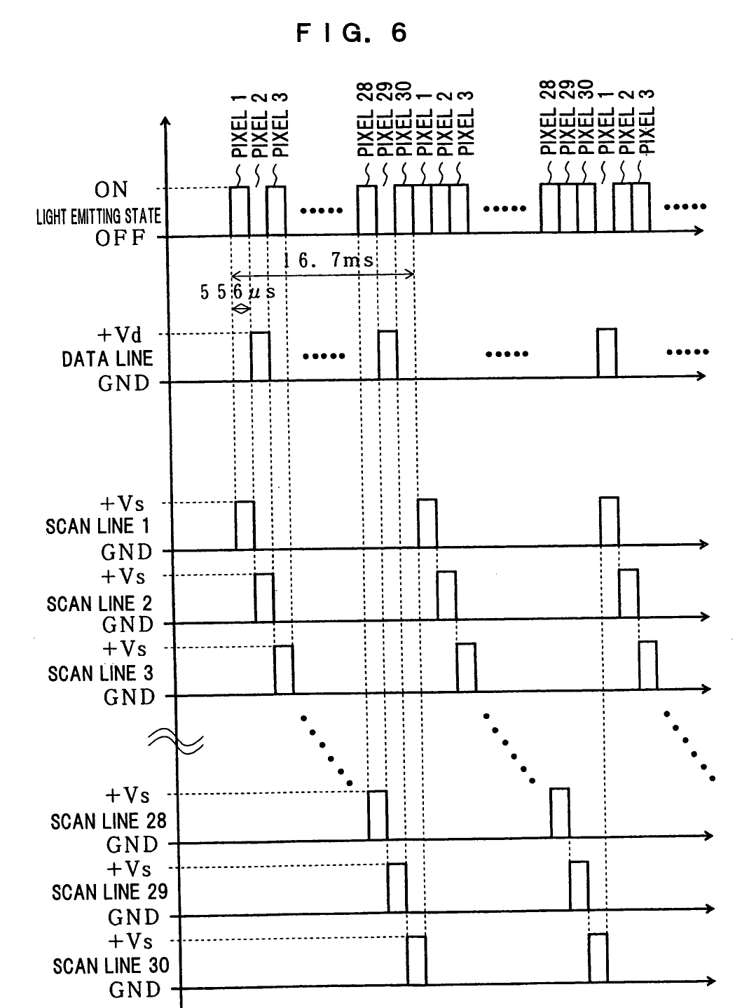

FIG. 6 is a diagram for explaining a drive example of the organic EL display device of Example 1 of the present invention, showing a drive example for a frame frequency of 60 Hz (cycle 16.7 ms≈1000 ms/60).

In Example 1, since the scan region 33 is divided into eight and the number of scan lines in one scan region 33 is 30, a width of a drive signal given to one scan line is 556 μs (≈16.7 ms/30).

At the time of driving, the eight scan regions 33 are scan driven simultaneously, and a drive signal is transmitted to the pixels in the respective scan regions 33 through the data line 32 exclusive for each region.

In this configuration, when all the pixels were lighted up, the luminance was 100 cd/m².

Next the operational effect of Example 1 of the present invention is confirmed by comparing it with a case in which a conventional bottom emission type organic EL display device is formed according to the same pattern rule as that of Example 1 of the present invention.

(1) In the Case of a Bottom Emission Structure, with the Scan Region Divided into Two

The number of scan lines in one scan region becomes 120 (=240/2), and the width of the drive signal given to one scan line becomes 139 μs (≈16.7 ms/120).

Moreover, the light emitting region is formed so that the data line also serves as a pixel electrode, and becomes 0.19 mm×0.19 mm according to the width of the upper electrode without the contact hole, and the aperture ratio becomes 90%.

Accordingly, a ratio of the scan signal width with respect to that in Example 1 of the present invention becomes 0.25 times (=139/556), and a ratio of the aperture ratio becomes 1.4 times (=90/64). As a result, the luminance becomes 35 cd/m² (=100 cd/m² 0.25×1.4), which means that in Example 1 of the present invention, luminance of about three times can be obtained.

(2) In the Case of the Bottom Emission Structure, with the Scan Region Divided into Four

The number of scan lines in one scan region becomes 60 (=240/4), and the width of the drive signal given to one scan line becomes 278 μs (≈16.7 ms/60).

Moreover, the light emitting region becomes 0.12 mm×0.19 mm according to light-shielding by the data line width 0.04 mm×2 and the width of the upper electrode without the contact hole, and the aperture ratio becomes 57%.

Accordingly, the ratio of the scan signal width with respect to that in Example 1 of the present invention becomes 0.5 times (=278/556), and the ratio of the aperture ratio becomes 0.89 times (=57/64). As a result, the luminance becomes 45 cd/m² (=100 cd/m² ×0.5×0.89), which means that in Example 1 of the present invention, luminance of about two times can be obtained.

(3) In the Case of the Bottom Emission Structure, with the Scan Region Divided into Eight

The number of scan lines in one scan region becomes 30 (=240/8), and the width of the drive signal given to one scan line becomes 556 μs (≈16.7 ms/30).

Moreover, the light emitting region becomes 0.04 mm×0.19 mm according to shading by the data line width 0.04 mm×4 and the width of the upper electrode without the contact hole, and the aperture ratio becomes 19%.

Accordingly, the ratio of the scan signal width with respect to that in Example 1 of the present invention becomes 1 times (=556/556), and the ratio of the aperture ratio becomes 0.3 times (19/64). As a result, the luminance becomes 30 cd/m² (=100 cd/m² 1×0.3), which means that in Example 1 of the present invention, luminance of about three times can be obtained.

From the above comparison, it is clear that the configuration according to the present invention is effective for improving the luminance two or three times that in the conventional example, and particularly, it is seen that more advanced high definition can be realized, and as the division number increases, the effect becomes high.

An example of the present invention has been described above. However, the present invention is not limited to the conditions and configuration described in the example, and can be variously changed. For example, the material forming the organic EL layer shown in the above example is only an example, and the material of the organic EL layer can be appropriately selected from known organic EL materials, according to the luminescent color.

Furthermore, in the above example, a glass substrate is used as the substrate, but the substrate is not limited to a glass substrate, and a plastic substrate or a resin film may be used. Moreover, since the display device is a top emission type, it is not necessary to use a transparent substrate, and a metal plate coated with an insulator may be used.

Furthermore, in the above example, the data lines are formed from Al, but the material is not limited to Al, and a conductive material having a low specific resistance as with Al, such as Ag may be used.

Moreover, in the above example, the pixel electrodes are formed by patterning using the photo-etching process, but they may be patterned by means of a mask deposition method using a metal mask.

Furthermore, the functions of the anode and the cathode with respect to each electrode are optional, and for example, the pixel electrodes may be formed of laminated layers of Al and ITO, and designated as the anode, and the organic EL layer may be formed by sequentially laminating the hole injection layer, the hole transport layer, the light emitting layer, the electron transport layer, and the electron injection layer, on the ITO surface. A semitransparent Al thin layer having a thickness of, for example, 2 nm may be then provided as the upper electrode and designated as the cathode.

Moreover, in the above example, to avoid a decrease in the yield due to short circuit, the upper electrodes are provided at positions where these do not overlap projectively on the positions of the contact holes, but this is not an essential condition. The upper electrodes may be provided so as to overlap on the contact holes by devising a tapered shape or the like for the contact holes. In this case, since the upper electrodes can be formed in a width of 0.19 mm according to the above described pattern rule, the aperture ratio can be made 90%.

Furthermore, in the above example, terminals to be connected to all data lines and scan lines are provided, and these terminals are connected to an externally provided driving circuit by the FPC wiring, but the present invention is not limited to such a configuration. The number of the external connection terminals may be reduced by a configuration of Chip On Glass (COG) or Chip On Film (COF), in which a driver is directly mounted on the substrate in the display device.

Moreover, in the above example, ITO is used as the translucent material forming the upper electrodes, but the material is not limited to ITO, and other oxide conductive materials such as IZO or ZnO may be used.

Furthermore, in the above example, Al is used as the material for the pixel electrodes, but the material is not limited to Al, and Ag or Mo and the like, which are light-reflective materials like Al, may be used. Alternatively, a laminated material of a highly reflective material such as Al with an oxide conductive material such as ITO may be used, thereby enabling an increase in the light extraction efficiency.

Moreover, in the above example, when the sealing plate is bonded, a UV hardening adhesive is used, but the sealing plate may be bonded by heating and pressing using a thermosetting adhesive.

Furthermore, in the above example, an electron injection layer is provided, but an electron injection layer is not essential, and an electron transport layer may be provided directly on the pixel electrodes serving as the cathode.

Moreover, in the above example, a single color display device has been described for brevity of explanation, but a plurality of colors may be appropriately combined to form a color display device. Particularly, the present invention is applicable to a case in which a full color display device is formed by combining RGB light emitting elements.

The present invention includes the following aspects.
1. An organic electroluminescent display device in which a wiring layer, an insulating layer 3, first electrodes, an organic electroluminescent layer 5, and second electrodes 6 are laminated on a substrate 1, with luminescence in the organic electroluminescent layer 5 being transmitted through the second electrodes 6, wherein the wiring layer sandwiched between a row of the first electrodes 4 and the substrate 1 comprises a plurality of feed wirings 2 extending in the row direction, and at least one first electrode 4 is connected to each feed wiring 2.
2. An organic electroluminescent display device according to 1, wherein a plurality of the first electrodes 4 is connected to each feed wiring, and the plurality of first electrodes 4 is arranged adjacent to each other, thereby forming a continuous pixel row.
3. An organic electroluminescent display device according to 2, wherein feed wirings 2 corresponding to pixel rows within a screen pass through a region of the pixel rows a little further to an outer periphery of the screen than the pixel row, and are drawn out to the outer periphery of the screen.
4. An organic electroluminescent display device according to 3, wherein a plurality of the second electrodes 6 is connected to the feed wirings in a direction crossing the pixel rows, to constitute a passive matrix driven pixel circuit in which the first electrodes 4 side is designated as signal lines, and the second electrodes 6 side is designated as scan lines.
5. An organic electroluminescent display device according to 4, wherein the feed wirings 2 are divided into two at the center of the screen, and are drawn out toward the two outer peripheries of the screen opposite to each other.
6. An organic electroluminescent display device according to 5, wherein a connecting portion 7 between the feed wiring 2 and the first electrode 4 is provided at a position where it does not overlap projectively on the second electrode 6.
7. An organic electroluminescent display device according to any one of 4 to 6, wherein the pixel circuit comprises M×N pixels, a scan region is divided into S regions, and the number of signal lines in one scan region is M lines and the number of scan lines is N/S lines.

In the present invention, the scan region is divided into a plurality of numbers, and data lines corresponding to the respective scan regions are embedded in a layer below the first electrodes so as not to interrupt extraction of luminescence, thereby enabling widening the width of the scan drive signal, while ensuring a large aperture ratio. As a result, luminance can be improved by two to three times the luminance in the conventional configuration, and a low cost can be realized as compared to a conventional high-cost multilayer wiring structure.

As an application example of the present invention, a two-dimensional matrix display device is a typical example, but the present invention is not limited to the display device, and can be applied to a large-size single light source such as a light source for mood illumination.

What is claimed is:

1. An organic electroluminescent display device in which a wiring layer, an insulating layer, first electrodes, an organic electroluminescent layer, and second electrodes are laminated on a substrate, with luminescence in the organic electroluminescent layer being transmitted through the second electrodes, wherein the wiring layer sandwiched between a row of the first electrodes and the substrate comprises a plurality of feed wirings extending in the row direction, and at least one first electrode is connected to each feed wiring.

2. An organic electroluminescent display device according to claim 1, wherein a plurality of first electrodes is connected to each feed wiring, and the plurality of first electrodes is arranged adjacent to each other, thereby forming a continuous pixel row.

3. An organic electroluminescent display device according to claim 2, wherein the feed wiring corresponding to a pixel row within a screen passes through a region of the pixel row a little further to an outer periphery of the screen than the pixel row, and is drawn out to the outer periphery of the screen.

4. An organic electroluminescent display device according to claim 3, wherein a plurality of the second electrodes is connected to the feed wirings in a direction crossing the pixel row, to constitute a passive matrix driven pixel circuit in which the first electrodes side is designated as signal lines, and the second electrodes side is designated as scan lines.

5. An organic electroluminescent display device according to claim 4, wherein the pixel circuit comprises M×N pixels, a scan region is divided into S regions, and the number of signal lines in one scan region is M lines, and the number of scan lines is N/S lines.

6. An organic electroluminescent display device according to claim 4, wherein a connecting portion between the feed wiring and the first electrode is provided at a position where it does not overlap projectively on the second electrode.

7. An organic electroluminescent display device according to claim 5, wherein a connecting portion between the feed wiring and the first electrode is provided at a position where it does not overlap projectively on the second electrode 6.

8. An organic electroluminescent display device according to claim 4, wherein the pixel circuit comprises M×N pixels, a scan region is divided into S regions, and the number of signal lines in one scan region is M lines, and the number of scan lines is N/S lines.

9. An organic electroluminescent display device according to claim 5, wherein the pixel circuit comprises M×N pixels, a scan region is divided into S regions, and the number of signal lines in one scan region is M lines, and the number of scan lines is N/S lines.

10. An organic electroluminescent display device according to claim 6, wherein the pixel circuit comprises M×N pixels, a scan region is divided into S regions, and the number of signal lines in one scan region is M lines, and the number of scan lines is N/S lines.

11. An organic electroluminescent display device according to claim 7, wherein the pixel circuit comprises M×N pixels, a scan region is divided into S regions, and the number of signal lines in one scan region is M lines, and the number of scan lines is N/S lines.
